(19) United States
(12) Patent Application Publication
(10) Pub. No.: US 2010/0006413 A1
(43) Pub. Date: Jan. 14, 2010

(54) ILLUMINATED KEYBOARD

(75) Inventors: Chao Lung Chang, Jhunan Township (TW); Liang-Ta Yeh, Shulin City (TW)

Correspondence Address: SNELL & WILMER L.L.P. (Main), 400 EAST VAN BUREN, ONE ARIZONA CENTER, PHOENIX, AZ, 85004-2202, US

(73) Assignee: DARFON ELECTRONICS CORPORATION, Gueishan (TW)

(21) Appl. No.: 12/499,948

(22) Filed: Jul. 9, 2009

(30) Foreign Application Priority Data
Jul. 9, 2008 (TW) 97212182

(51) Int. Cl. H01H 9/00

(52) U.S. Cl. 200/314

(57) ABSTRACT

The present invention provides an illuminated keyboard. The keyboard includes a base plate; a membrane switch above the base plate; at least one key member above the membrane switch; an electroluminescent sheet between the key member and the membrane switch; and at least one elastic member positioned on the electroluminescent sheet, the electroluminescent sheet supporting the elastic member, wherein when pressing the key member, the elastic member will be pushed to trigger the membrane switch.

### CROSS REFERENCE TO RELATED APPLICATIONS

This application claims the right of priority based on Taiwan Patent Application No. 97212182 entitled “ILLUMINATED KEYBOARD” filed on Jul. 9, 2008, which is incorporated herein by reference and assigned to the assignee herein.

### FIELD OF THE INVENTION

This invention relates to a keyboard, and more particularly relates to a keyboard with illumination function.

### BACKGROUND OF THE INVENTION

In the past as computers were too heavy to take along, people usually operated computers in a fixed place. To clearly see and distinguish each key on the keyboard, sufficient light should be provided in the fixed place. Nowadays, as portable computers and wireless Internet access become widespread, operating computers anywhere is available without being restricted to a fixed place. Therefore, an illuminated keyboard has been developed for users to clearly see the key members anywhere, especially in a dim place.

FIG. 1A illustrates a cross-sectional view of a conventional illuminated keyboard 10. FIG. 1B illustrates a perspective view of an electroluminescent sheet 13 of the conventional illuminated keyboard 10. As shown in the figures, the illuminated keyboard 10 includes a key member 11, a guiding sleeve 12, the electroluminescent sheet 13 and an elastic member 14. The illuminated keyboard 10 further includes a Mylar 15 supporting the elastic member 14. The electroluminescent sheet 13 is atop the Mylar 15 and formed with multiple openings 13a to be penetrated by the elastic members 14.

There are many drawbacks derived from the conventional illuminated keyboard 10. For example, the conventional electroluminescent sheet 13 is made with multiple openings 13a and hence its cost is relatively high. Further, for assembling the illuminated keyboard 10, an alignment procedure is necessary in order to put each elastic member 14 into each opening 13a, so that the assembly process is quite complex. Furthermore, in case replacing the electroluminescent sheet 13 is needed for maintaining the illuminated keyboard 10, the detaching process would also have been complex. Therefore, there is a need to provide a novel illuminated keyboard for addressing the problems of the conventional illuminated keyboards.

### SUMMARY OF THE INVENTION

The present invention provides an illuminated keyboard having an elastic member directly placed on an electroluminescent sheet. In other words, as compared with the conventional illuminated keyboard wherein the Mylar supports the elastic member, the present invention uses the electroluminescent sheet to support the elastic member. The present invention further provides another illuminated keyboard having an elastic member directly placed on a membrane switch and an electroluminescent sheet beneath the membrane switch. According to the present invention, the electroluminescent sheet may not necessarily be formed with openings, and thus may not require the alignment procedure during manufacturing, and the detaching process is also relatively simple.

According to one embodiment, the present invention provides an illuminated keyboard, comprising a base plate; a membrane switch above the base plate; at least one key member above the membrane switch; an electroluminescent sheet between the key member and the membrane switch; and at least one elastic member corresponding to each key member and positioned on the electroluminescent sheet, the elastic member having a bottom surface directly contacting a top surface of the electroluminescent sheet, wherein when pressing the key member, the elastic member is pushed downwardly to trigger the membrane switch.

According to another embedment, the present invention provides an illuminated keyboard, comprising a base plate; a membrane switch above the base plate; at least one key member above the membrane switch; an electroluminescent sheet beneath the membrane switch; and at least one elastic member corresponding to each key member and positioned on the membrane switch, the elastic member having a bottom surface directly connecting a top surface of the membrane switch, wherein when pressing the key member, the elastic member is pushed to trigger the membrane switch.

### BRIEF DESCRIPTION OF THE DRAWINGS

FIG. 1A illustrates a cross-section view of a conventional illuminated keyboard.

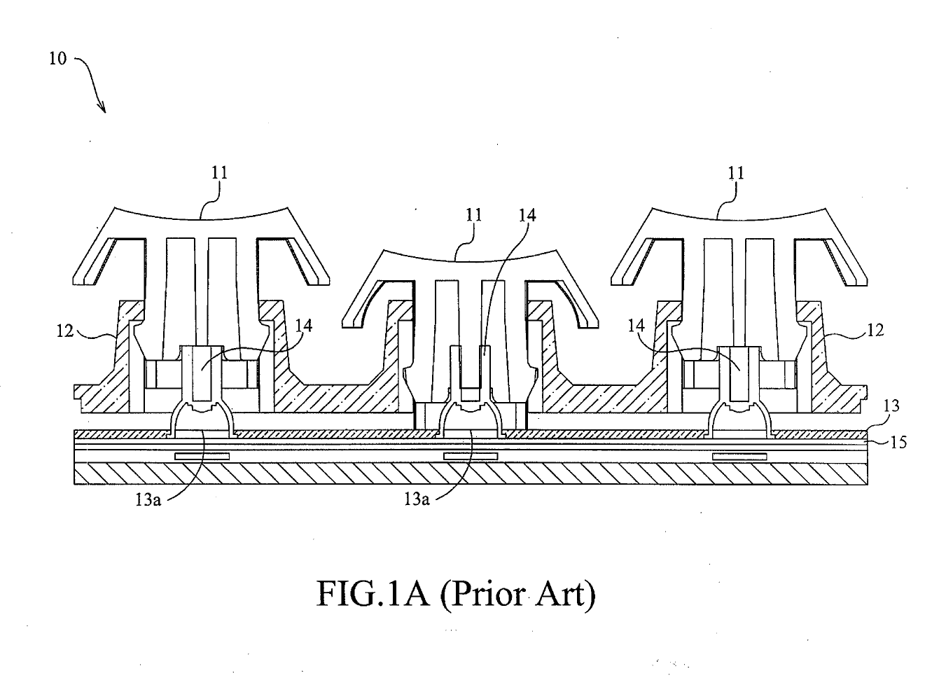

FIG. 1B is a perspective view of the electroluminescent sheet of the conventional illuminated keyboard of FIG. 1A.

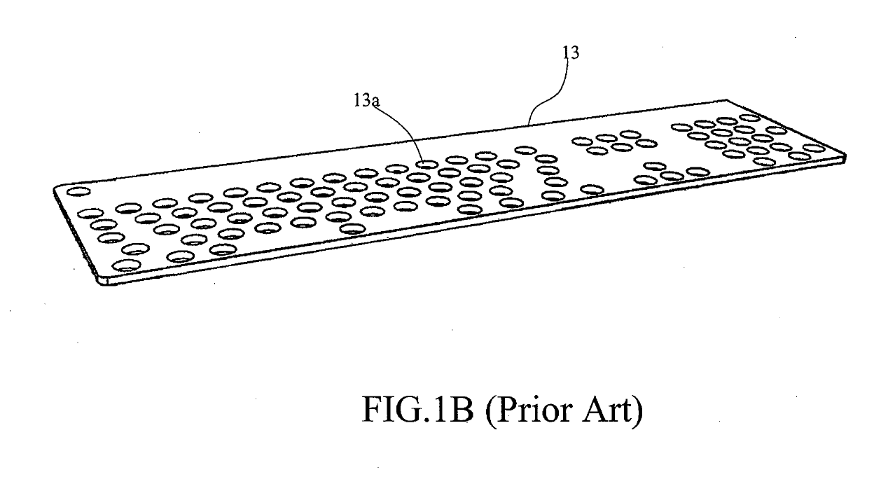

FIG. 2A illustrates an explosive view of an illuminated keyboard in accordance with a first embodiment of the present invention.

FIG. 2B is a cross-section view of the electroluminescent sheet of the illuminated keyboard of FIG. 2A.

FIG. 3 illustrates a cross-section view of an illuminated keyboard in accordance with a second embodiment of the present invention.

FIG. 4A is an explosive view of an illuminated keyboard in accordance with a third embodiment of the present invention.

FIG. 4B is a cross-section view of the electroluminescent sheet of the illuminated keyboard of FIG. 4A.

FIG. 5 is a cross-section view of an illuminated keyboard in accordance with a fourth embodiment of the present invention.

### DETAILED DESCRIPTION OF THE INVENTION

The preferred embodiments of the present invention will now be described in greater details by referring to the drawings that accompany the present application. It should be noted that the features illustrated in the drawings are not necessarily drawn to scale. Descriptions of well-known components, materials, and process techniques are omitted so as to not unnecessarily obscure the embodiments of the invention.

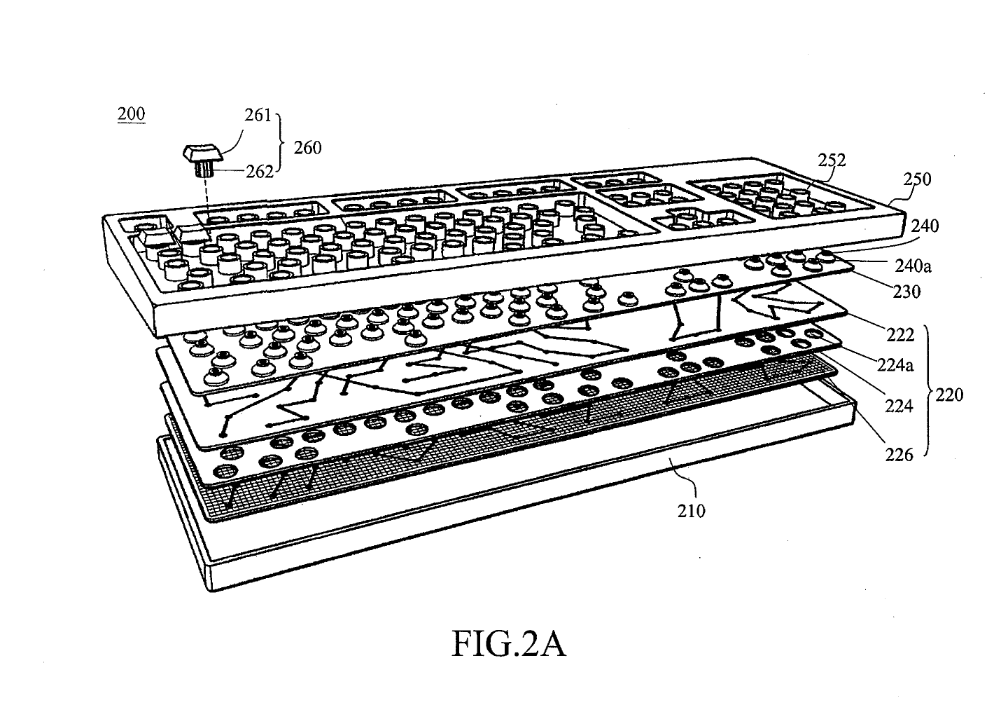

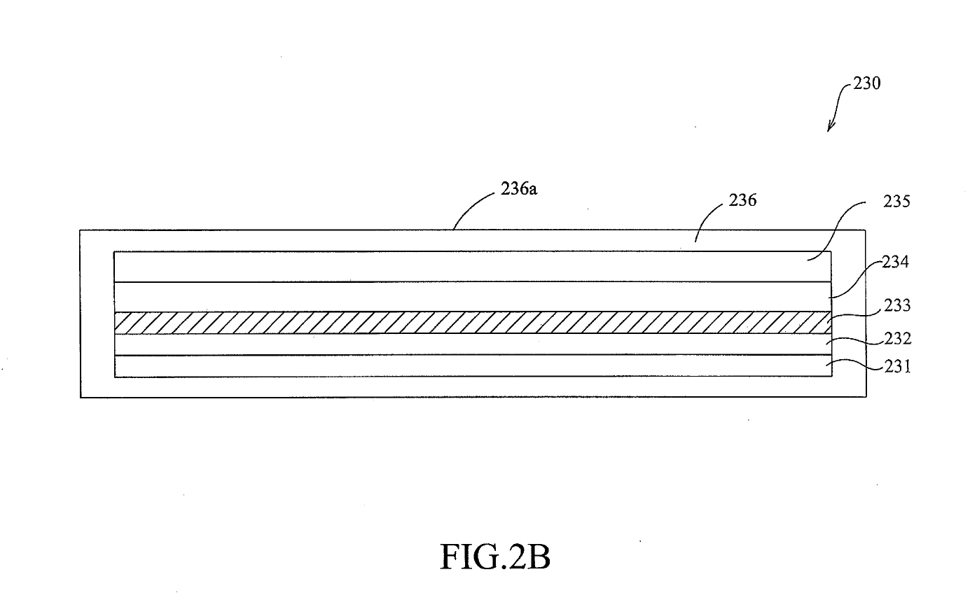

FIG. 2A to FIG. 2B illustrate the first embodiment of the present invention, wherein FIG. 2A is an explosive view of an illuminated keyboard 200 and FIG. 2B is a cross-section view of an electroluminescent sheet 230 of the illuminated keyboard 200.

As shown in the figures, the illuminated keyboard 200 includes a base plate 210, a membrane switch 220, an electroluminescent sheet 230, at least one elastic member 240, a casing 250, and at least one key member 260 inserted into the casing 250. The term “at least one” utilized in the specification refers to the meanings including “a single one” and “more than one.”

As shown in FIG. 2A, the key member 260 is commonly structured as a T-shape, which having a keycap 261 and a key pillar 262 extending downwardly. The casing 250 is placed between the key member 260 and the elastic member 240. The casing 250 is formed with at least one guiding sleeve 252 corresponding to each key member 260. The key pillar 262 is penetrated into the guiding sleeve 252. The elastic members 240, each corresponding to one key member 260, are placed beneath the casing 250. The elastic member 240 includes a flexible structure that is deformable when being pressed. When a user presses the key member 260, the key pillar 262 pushes the elastic member 240 to touch and deform the underlying membrane switch 220, thereby trigger an electric signal. When the user releases the key member 260, a resilient force of the elastic member 240 elevates the key member 260. An engagement mechanism is provided between the guiding sleeve 252 and the key pillar 262 to prevent the key member 260 from departing from the casing 250. The key member 260 and the casing 250 can be made by any suitable materials, among which a higher transparent material is preferred in order to help lights from the electro-luminescent sheet 230 pass through.

As shown in FIG. 2A, the elastic member 240 is placed on the top surface of the electroluminescent sheet 230. The electroluminescent sheet 230 supports the elastic member 240. Specifically, a bottom surface 240a of the elastic member 240 is directly connected to the top surface 236a of the electroluminescent sheet 230. The electroluminescent sheet 230 may be any suitable sheet including a well-known structure as shown in FIG. 2B. The electroluminescent sheet 230 includes a first electrode layer 231; a dialetric Layer 232; a light-emitting layer 233, a second electrode layer 234; a protective layer 235 and an isolation layer 236. The first electrode layer 231 and the second electrode layer 234 may respectively connect with an external power source. The isolation layer 236 is used for electronically insulating from the membrane switch 220.

Referring to FIG. 2A, the membrane switch 220 including a first circuit layer 222; a separation layer 224, and a second circuit layer 226. The separation layer 224 is formed with at least one opening 224a, each corresponding to one key member 240. When a user presses the key member 260, the key member 260 presses forward the elastic member 240 to push the first circuit layer 222, such that the first circuit layer 222 touches the second circuit layer 226 via the opening 224a and thus an electric signal is triggered.

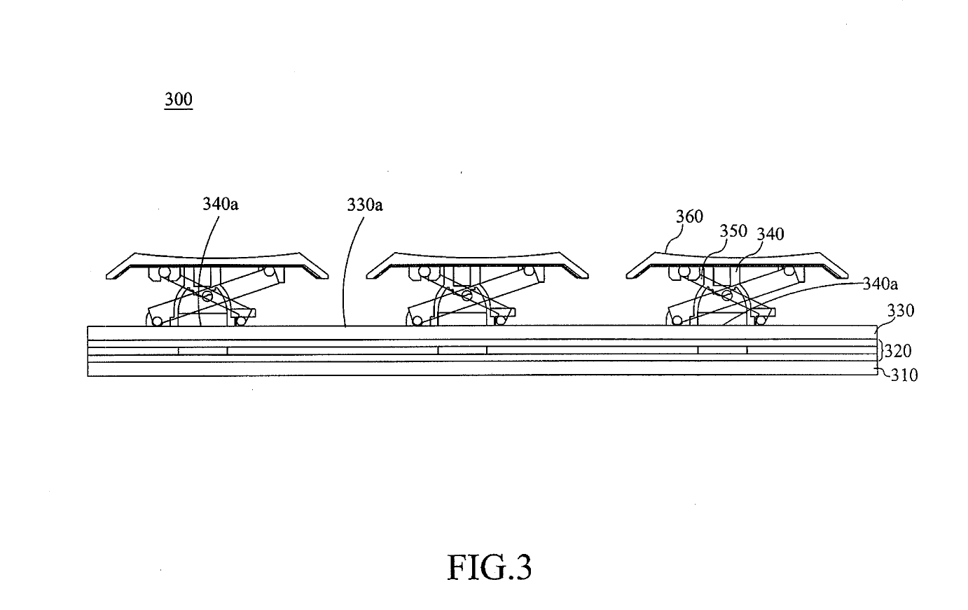

FIG. 3 illustrates a second embodiment of the present invention. In comparison with the first embodiment, the second embodiment utilizes a scissor arm replacing the guiding sleeve 252 of the first embodiment. Specifically, as shown in FIG. 3, the illuminated keyboard 300 includes a base plate 3 10, a membrane switch 320, a electroluminescent sheet 330, at least one elastic member 340, at least one scissor arm 350 and at least one key member 360 covering the elastic member 340. Each key member 360 corresponds to one elastic member 340 and one scissor arm 350. The scissor arm 330 directly connects the corresponding key member 360 and the electroluminescent sheet 330. The scissor arm 330 movably engages with the corresponding key member 360 in such a way that the key member 360 can selectively move up and down. When a user presses the key member 360, the elastic member 340 is pushed to touch the underlying membrane switch 320. When the user releases the key member 360, the key member 360 returns to its original position by a resilient force of the elastic member 340. Note that, as aforementioned in the first embodiment, the elastic member 340 is placed on the top surface of the electroluminescent sheet 330. That is, a bottom surface 340a of the elastic member 340 is directly connected to a top surface 330a of the electroluminescent sheet 330. The detailed structures of the electroluminescent sheet 330 and the membrane switch 320 resemble those of the first embodiment, and consequently a further description is omitted.

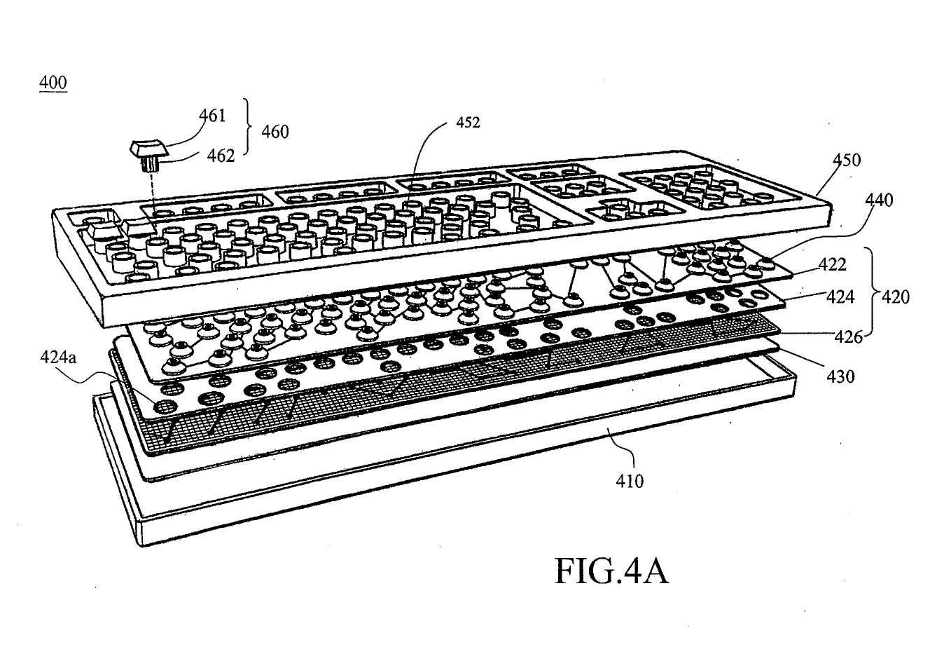

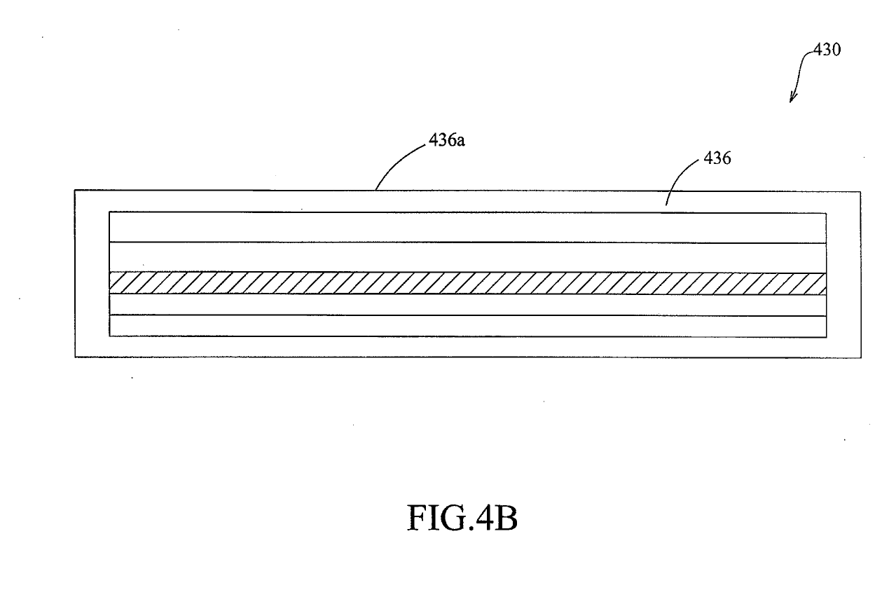

FIG. 4A and FIG. 4B illustrate the third embodiment of the present invention. According to the third embodiment, an illuminated keyboard 400 includes an elastic member 440 directly placed on a membrane switch 420 and an electroluminescent sheet 430 placed beneath the membrane switch 420. Specifically, as shown in the figures, the illuminated keyboard 400 includes a base plate 410, the membrane switch 420 on the base plate 410; the electroluminescent sheet 430 between the membrane switch 420 and the base plate 410; at least one elastic member 440 placed on the membrane switch 420; a casing 450 placed on the elastic member 440; and at lest one key member 460 inserted into the casing 450. The key member 460 is commonly structured as a T-shape, having a keycap 461 and a key pillar 462 extending downwardly. The casing 450 is placed between the key member 4260 and the elastic member 440. The casing 450 is formed with at least one guiding sleeve 452 corresponding to each key member 460. The key pillar 462 is fitted into the guiding sleeve 452. The elastic members 440, each corresponding to each key member 460, are placed beneath the casing 450. Any suitable materials among which a higher transparent material is preferred can make the key member 460 and the casing 450. The membrane switch 420 includes a first circuit layer 422; a separation layer 424; and a second circuit layer 426. The separation layer 424 is formed with at least one opening 424a, each opening corresponding to one elastic member 440. When a user presses the key member 460, the key member 460 pushes the elastic member 440 to press and deform the underlying first circuit layer 420. Consequently, the first circuit layer 422 touches the second circuit layer 426 to trigger an electric signal. In the third embodiment, the elastic member 440 is directly placed on the first circuit layer 422, i.e. the elastic member 440 directly contacts the first circuit layer 422. In another embedment, the first circuit layer 422 may include a protective coating applied on an outer surface uncovered by the elastic member 440. In still another embodiment, a protective coating may exist between the first circuit layer 422 and the elastic member 440. The electroluminescent sheet 430 of the third embodiment is illustrated in FIG. 4B, which is substantially similar to the electroluminescent sheet 230 of the first embodiment. Note that the isolation layer 436 is formed with a top surface 436a. The isolation layer 436 is not only electrically isolative but also adhesive. Thus, the electroluminescent sheet 430 is affixed on the second circuit layer 426.

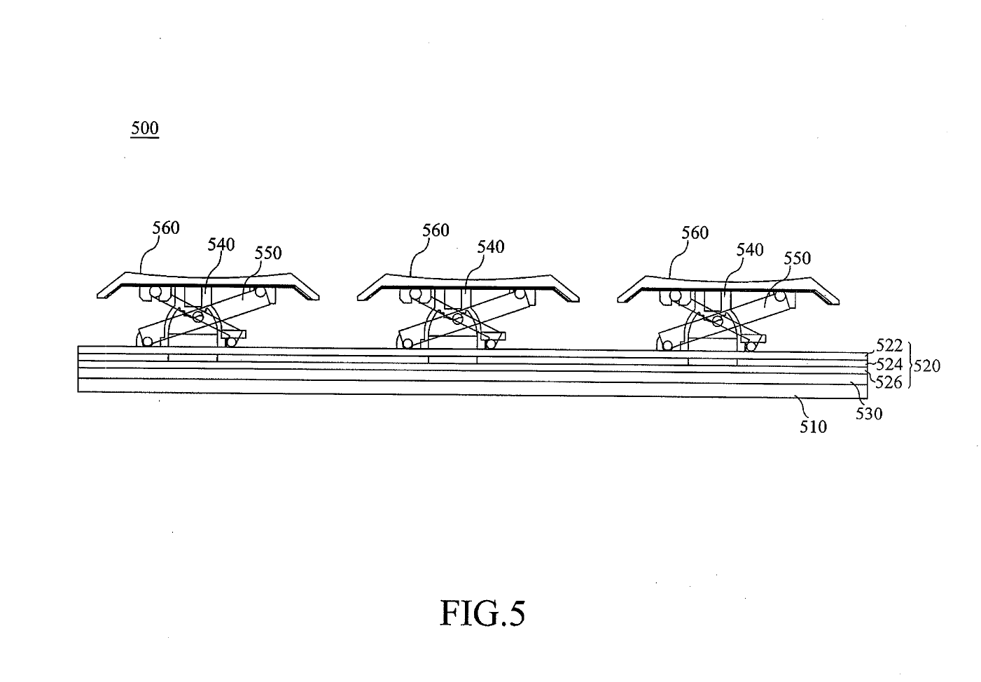

FIG. 5 illustrates a fourth embodiment of the present invention. The fourth embodiment differs from the third embodiment in that a scissor arm 550 is utilized replacing the guiding sleeve 252 in the third embodiment. Specifically, as shown in FIG. 5, the illuminated keyboard 500 includes a base plate 510, a membrane switch 520, an electroluminescent sheet 530, at least one elastic member 540, at least one scissor arm 550 and at least one elastic member 560 covering the corresponding elastic member 540. The scissor arm 550 directly connects the key member 560 and the membrane switch 520. As aforementioned in the second embedment, the elastic member 540 is also placed on the first circuit layer 522 of the membrane switch 520, i.e. the elastic member 540 directly contacts the first circuit layer 522. In another embedment, the first circuit layer 522 may include a protective coating applied on an outer surface uncovered by the elastic member 540. In still another embodiment, a protective coating may exist between the first circuit layer 522 and the elastic member 540. Some members of the fourth embedment resemble those described in the third embedment, and thus the further description is omitted.

Although specific embodiments have been illustrated and described, it will be obvious to those skilled in the art that various modifications may be made without departing from what is intended to be limited solely by the appended claims.

1. An illuminated keyboard, comprising:
a base plate;
a membrane switch above the base plate;
at least one key member above the membrane switch;
an electroluminescent sheet between the key member and the membrane switch; and
at least one elastic member corresponding to each key member and positioned on the electroluminescent sheet, the electroluminescent sheet supporting the elastic member, wherein when pressing the key member, the elastic member is pushed to trigger the membrane switch.

2. The illuminated keyboard according to claim 1, wherein a bottom surface of the elastic member is directly connected with a top surface of the electroluminescent sheet.

3. The illuminated keyboard according to claim 1, wherein the key member is made of transparent materials.

4. The illuminated keyboard according to claim 1, the membrane switch comprising:
a first circuit layer;
a separation layer, having at least one opening, each opening corresponding to each elastic member;
a second circuit layer to be touched with the first circuit layer via the opening when the key member presses the elastic member to push the first circuit layer.

5. The illuminated keyboard according to claim 1, the electroluminescent sheet comprising:
a first conductive layer;
a light emitting layer; and
a second conductive layer.

6. The illuminated keyboard according to claim 1, wherein the electroluminescent sheet further comprises an isolation layer for electronically insulating from the membrane switch.

7. The illuminated keyboard according to claim 1, further comprising a casing between the key member and the elastic member, the casing having at least one guiding sleeve corresponding to each key member, the key member downwardly extending a pillar for entering the gilding sleeve.

8. The illuminated keyboard according to claim 1, further comprising at least a scissor arm directly connecting the key member with the electroluminescent sheet.

9. An illuminated keyboard, comprising:
a base plate;
a membrane switch above the base plate;
at least one key member above the membrane switch;
an electroluminescent sheet beneath the membrane switch; and
at least one elastic member corresponding to each key member and positioned on the membrane switch, the elastic member having a bottom surface directly connecting a top surface of the membrane switch,
wherein when pressing the key member, the elastic member is pushed to trigger the membrane switch.

10. The illuminated keyboard according to claim 9, wherein the key member is made of transparent materials.

11. The illuminated keyboard according to claim 9, the membrane switch comprising:
a first circuit layer;
a separation layer, having at least one opening, each opening corresponding to each elastic member;
a second circuit layer to be touched with the first circuit layer via the opening when the key member pushes the elastic member to press the first circuit.

12. The illuminated keyboard according to claim 11, wherein the elastic member contacts the first circuit layer.

13. The illuminated keyboard according to claim 11, the electroluminescent sheet comprising:
a first conductive layer;
a light emitting layer;
a second conductive layer; and
an isolation layer for electronically insulating from the second circuit layer.

14. The illuminated keyboard according to claim 13, wherein the isolation layer is adhesive so as to affix the electroluminescent sheet to the second circuit layer.

15. The illuminated keyboard according to claim 1, further comprising a casing between the key member and the elastic member, the casing having at least one guiding sleeve corresponding to each key member, the key member downwardly extending a pillar for entering the gilding sleeve.

16. The illuminated keyboard according to claim 1, further comprising at least a scissor arm directly connecting the key member with the electroluminescent sheet.
